(19) United States
(12) Patent Application Publication
(10) Pub. No.: US 2005/0234700 A1
(43) Pub. Date: Oct. 20, 2005

(54) Autonomic method, system and program product for translating content

(75) Inventors: Yongcheng Li, Cary, NC (US); Yuping C. Wu, Cary, NC (US); ChunShan A. Zhang, Cary, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/824,700

(22) Filed: Apr. 15, 2004

(51) Int. Cl. G06F 17/28

(52) U.S. Cl. 704/2

(57) ABSTRACT

Under the present invention, a user will provide content to be translated to a translation engine. After making the translation, the user will be provided with the results and transaction process details specifying the context of the translation. Based on the context, the user can provide feedback regarding the quality of the translation. Then, based on the feedback, the translation resource used to make the translation can be updated.

### BACKGROUND OF THE INVENTION

1. Field of the Invention

In general, the present invention relates to an autonomic method, system and program product for translating content. Specifically, a user requesting translation of content is presented with translation process details so that improved feedback pertaining to the translation can be given, and any necessary updates to the translation resource can be made.

2. Related Art

With the advance of new technology, more and more information is generated around the world in different languages. As such, translation has become a key issue in information sharing across countries and regions using different languages. Manual translation can no longer satisfy the needs due to its slowness and high cost. Accordingly, machine (e.g., computer-based) translation has become an important technology globally.

Even though machine translation has been studied for several years, the quality of existing machine translation techniques is still far from satisfactory. One of the key issues of machine translation is that the same term might have several different meanings. For example, the term “pin” could be used to refer to a sharp metal object, or a personal identification number. As such, to make an accurate translation of the term, the machine translation “engine” would need to recognize the correct context of the term.

One existing approach to machine translation is to create and use a field-specific dictionary in addition to a base dictionary to improve the translation quality. Unfortunately, there are several drawbacks with this approach. First, it is extremely difficult to build a complete field dictionary before people start to use the machine translation engine. It is even more difficult to define and check the field dictionary's completeness. In addition, terminology is rapidly changing in many fields. As such, the meaning of a term or phrase could change, and new terms could be added. Accordingly, a static field dictionary fails to meet the needs of machine translation.

Still other approaches have attempted to provide translation dictionaries that are updateable. Unfortunately, none of the existing approaches provide the user with translation process details that set forth the context of translation. As such, no existing approach allows a user to provide optimal feedback so that the dictionary can be accurately updated.

In view of the foregoing, there exists a need for an autonomic method, system and program product for translating content. Specifically, a need exists for a system in which translation process details specifying the context in which the content is translated is presented to a user. Based on the details, the user can provide accurate feedback regarding the quality of the translation. Then, based on the feedback, the resource used to translated the content can be updated.

### SUMMARY OF THE INVENTION

In general, the present invention provides an autonomic method, system and program product for translating content. Specifically, under the present invention, a user will provide content to be translated to a translation engine. After making the translation, the user will be provided with the results and transaction process details specifying the context of the translation. Based on the context, the user can provide feedback regarding the quality of the translation. Then, based on the feedback, the translation resource used to make the translation can be updated.

A first aspect of the present invention provides an autonomic translation method, comprising: receiving content to be translated; translating the content from a first language to a second language using a translation resource; providing translation process details corresponding to the translation; and receiving feedback pertaining to the translation based on the translation process details.

A second aspect of the present invention provides a computer-implemented business method for autonomic content translation, comprising: receiving content to be translated from a user; translating the content from a first language into a second language using a translation resource; providing translation process details specifying a context of the translation to the user; receiving feedback from the user pertaining to a quality the translation based on the translation process details; and updating the translation resource based on the feedback.

A third aspect of the present invention provides an autonomic translation system, comprising: a content reception system for receiving content to be translated from a user; a translation system for translating the content from a first language into a second language using a translation resource; a translation context system for providing translation process details specifying a context of the translation to the user; and a feedback reception system for receiving feedback from the user pertaining to a quality the translation based on the translation process details.

A fourth aspect of the present invention provides a program product stored on a recordable medium for translating content, which when executed, comprises: program code for receiving content to be translated from a user; program code for translating the content from a first language into a second language using a translation resource; program code for providing translation process details specifying a context of the translation to the user; and program code for receiving feedback from the user pertaining to a quality the translation based on the translation process details.

Therefore, the present invention provides an autonomic method, system and program product for translating content.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an autonomic system for translating content according to the present invention.

FIG. 2 depicts an illustrative interface page for providing content to be translated according to the present invention.

FIG. 3 depicts an illustrative interface page for showing the content after translation according to the present invention.

FIG. 4 depicts an illustrative interface page for showing translation process details and for providing feedback according to the present invention.

FIG. 5 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides an autonomic method, system and program product for translating content. Specifically, under the present invention, a user will provide content to be translated to a translation engine. After making the translation, the user will be provided with the results and transaction process details specifying the context of the translation. Based on the context, the user can provide feedback regarding the quality of the translation. Then, based on the feedback, the translation resource used to make the translation can be updated.

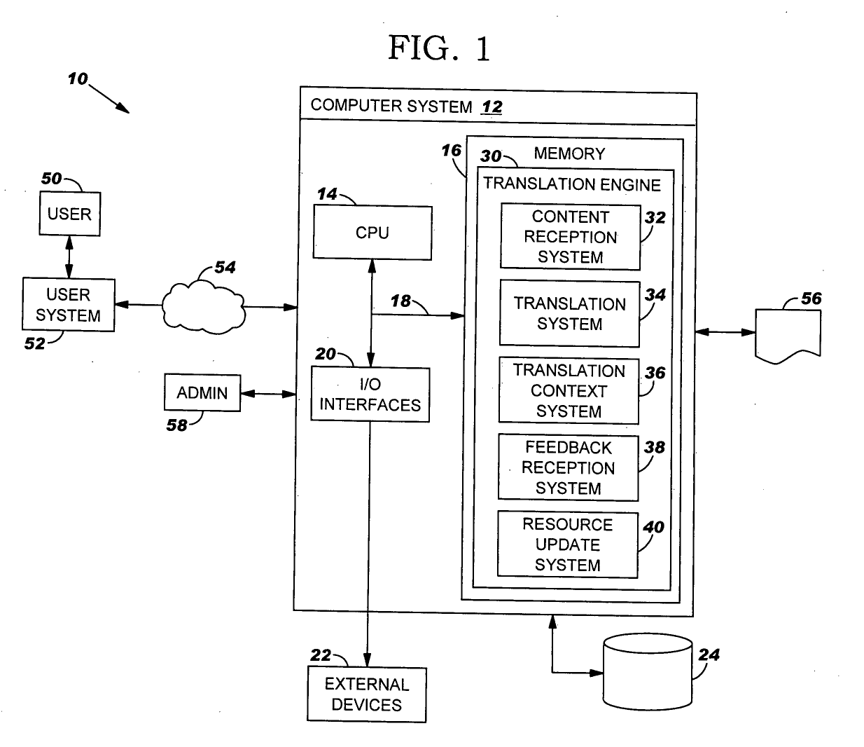

Referring now to FIG. 1, an autonomic system 10 for translating content is shown. As depicted, system 10 includes computer system 12 that is intended to represent any type of computerized device capable of carrying out the functions described below. For example, computer system 12 could be a workstation, a laptop, a handheld device, etc. In addition, the teachings of the present invention could be implemented over network 54 as shown, or within a free-standing system that user 50 could directly access (e.g., without user system 52).

In the case of the former, network 54 could be any type of network such as Internet, a local area network (LAN), a wide area network (WAN), a virtual private network (VPN), etc., and user 50 could operate user system 52 to communicate with computer system 12 in a client-server or server-server environment. Communication between user system 52 and computer system 12 could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this case, an Internet Service Provider could be used to establish connectivity to computer system 12.

As further depicted in FIG. 1, computer system 12 generally comprises central processing unit (CPU) 14, memory 16, bus 18, input/output (I/O) interfaces 20, external devices/resources 22 and storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, etc. Moreover, similar to CPU 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LCD screen, handheld device, keyboard, mouse, voice recognition system, speech output system, printer, monitor/display, facsimile, pager, etc. Bus 18 provides a communication link between each of the components in computer system 12 and likewise may comprise any known type of transmission link, including electrical, optical, wireless, etc.

Storage unit 24 can be any system (e.g., database) capable of providing storage for information under the present invention. Such information could include, for example, content input by user 50, translation results, translation process details, etc. As such, storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown in memory 16 of computer system is translation engine 30, which includes content reception system 32, translation system 34, translation context system 36, feedback reception system 38 and resource update system 40. As will be further explained below, each of these systems contains program code for generating interface pages and for performing the underlying functions of the present invention. Interface pages generated by translation engine 30 will typically be communicated to user system 52 for display in a web browser or the like. When user 50 wishes to have content translated from a first (source) language into a second (destination) language, user 50 will access translation engine 30 (e.g., over network 54 via user system 52). To this extent, the present invention could be implemented as a (computer-implemented) business method in which computer system 12 is operated and/or deployed by a service provider, and in which users pay a subscription or other fee-based structure for the translation services described herein. In such a case, user 50 could be assigned a log-in identification and password for any necessary authentication and authorization that is performed.

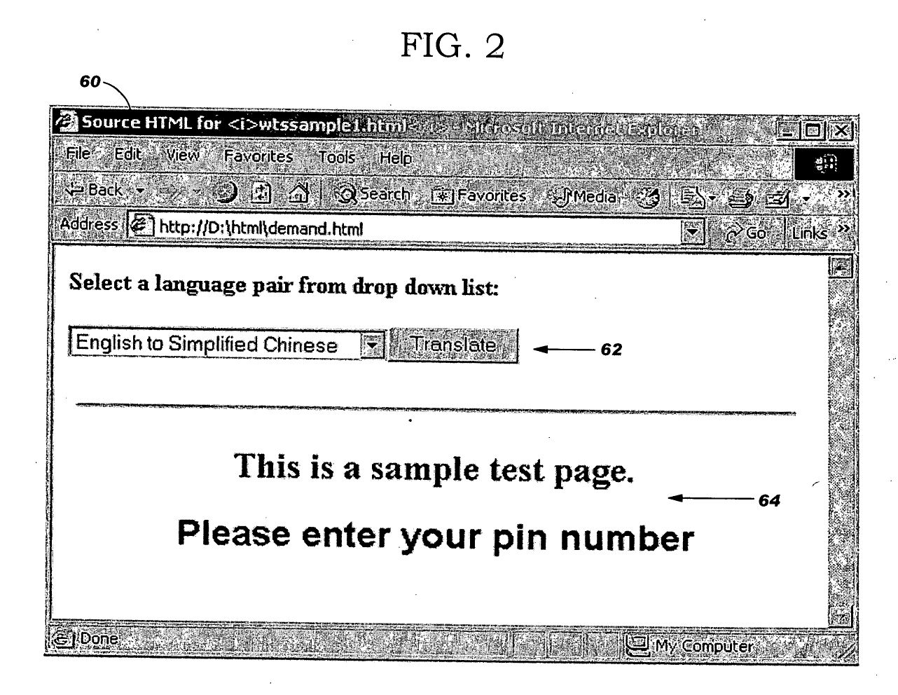

Assume in an illustrative example that user 50 is authorized to utilize translation engine 30. In this event, content reception system 32 will generate and provide an input interface page for user 50 to provide (e.g., input) content to be translated, and to select the languages involved with the translation. Referring to FIG. 2, an illustrative input interface page 60 is shown. As depicted, input interface page 60 includes a mechanism 62 for user 50 (FIG. 1) to select the first and second language involved with the translation. Input interface page 60 also includes an area for user 50 to provide the content 64 he/she wishes to have translated. As shown in FIG. 2, user 50 wishes to have the following two sentences translated:
THIS IS A SAMPLE TEST PAGE.
PLEASE ENTER YOUR PIN NUMBER.
   It should be appreciated that mechanism 62 for selecting languages is shown as a drop-down menu for illustrative purposes only, and that any other known mechanism could be implemented herein. For example, mechanism 62 could comprise one or more blank fields for inputting languages.

In any event, referring back to FIG. 1, once user 50 has selected the source and destination languages and provided the content to be translated, translation system 34 will perform the lingual translation. To this extent, it should be appreciated that translation system 34 could incorporate components from any translation system now known or later developed. In general, translation system will utilize a translation resource 56 such as a field dictionary or the like to perform the translation. To this extent, translation resource 56 could be stored locally to computer system 12, or remotely (as shown).

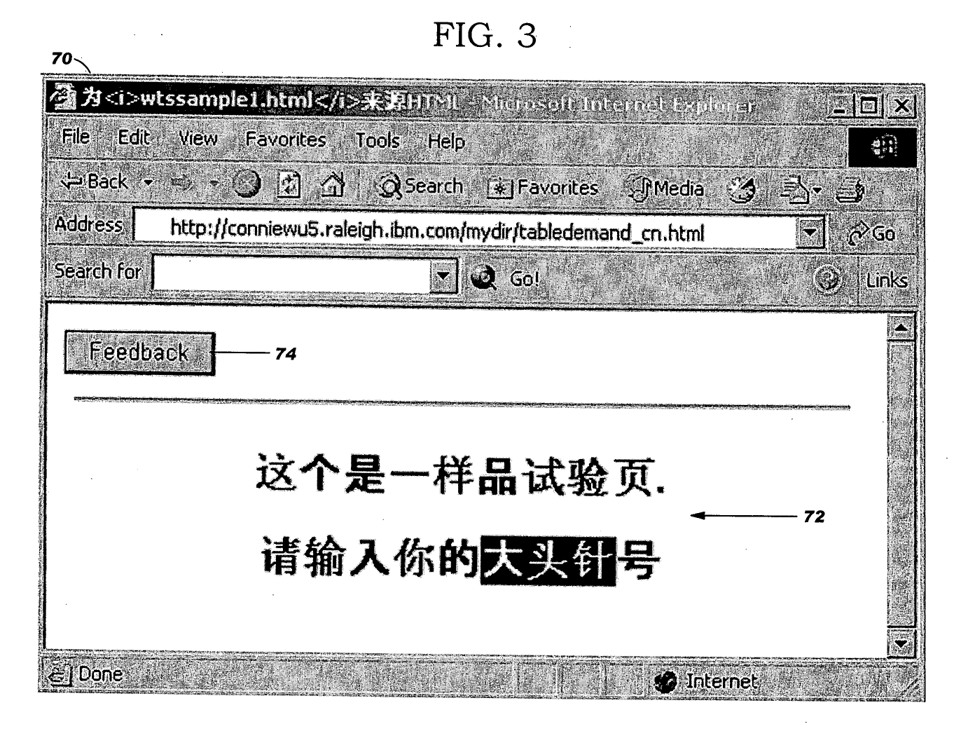

In any event, under the present invention, translation system 32 is configured to display a result interface page that not only provides user 50 with the results of the translation, but also with a mechanism for providing feedback. For example, referring to FIG. 3, an illustrative result interface page 70 is shown. As shown, result interface page 70 shows content 72 after translation to a selected destination language, and includes a mechanism 74 for providing feedback (e.g., a button). As further shown in FIG. 3, the translation of the term “pin” has been highlighted. As indicated above, it is often the case that a single term can multiple meanings. In this example, the term “pin” could not only be used to refer to a personal identification number, but also to a sharp metal object. When user 50 (FIG. 1) provided content 64 (FIG. 2) via input interface page 60 (FIG. 2), user 50 was referring to a personal identification number. However, the term “pin” was actually translated to the sharp metal object meaning.

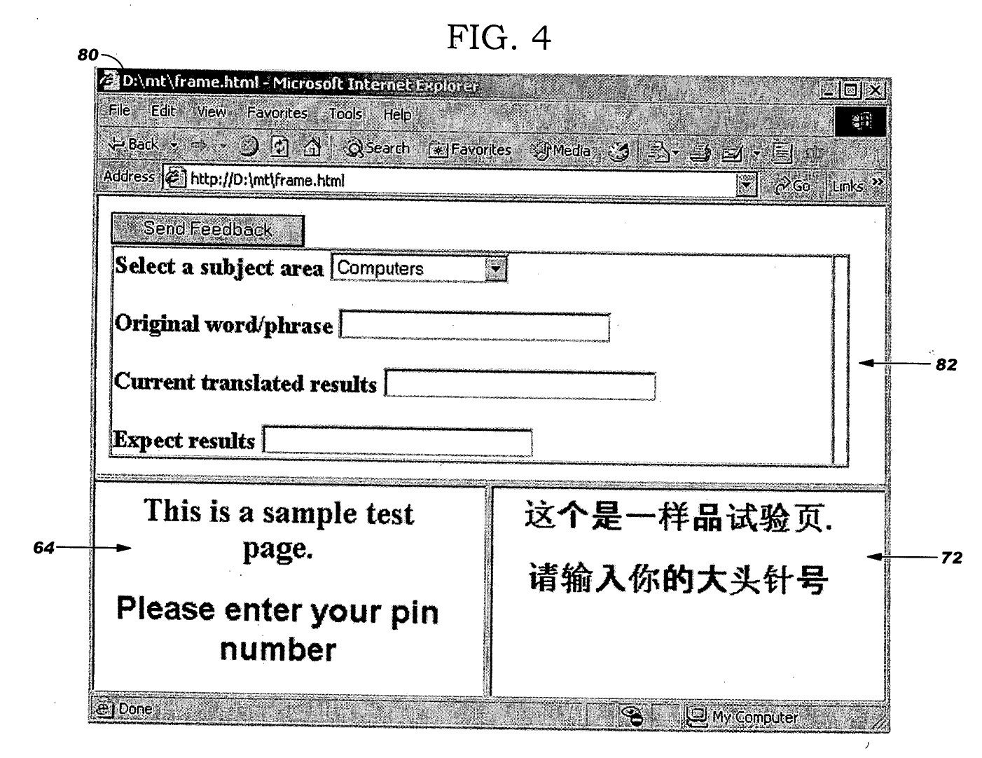

In this case, user 50 (FIG. 1) may wish to provide feedback so that future translations can be improved. As such, user 50 will select feedback mechanism 74. Under the present invention, when user 50 selects feedback mechanism 74, translation context system 36 (FIG. 1) will display a feedback interface page that not only allows user 50 to provide feedback for the translation, but also contains translation content details corresponding to the underlying lingual translation. For example, referring to FIG. 4, an illustrative feedback interface page 80 is depicted. As shown, feedback interface page 80 shows translation content details by displaying both the content 64 input by user, and the translation results 72. Thus, the translation process details specify a context in which the content was translated from the first language to the second language. These details allow user 50 (FIG. 1) to provide improved feedback.

As further shown in FIG. 4, feedback interface page 80 includes several fields 82 for user 50 (FIG. 1) to provide feedback. For example, user 50 could: select a subject area of the term or content; input the original term; input the current translated result; and input an expected result. Without seeing the translation process details under the present invention, user 50 would not be able to provide such an optimal level of feedback. Rather, user 50 might only be able to indicate that the translation was erroneous.

Referring back to FIG. 1, When user 50 submits/sends the feedback back to computer system 12, it will be received by feedback reception system 38. Upon receipt, resource update system 40 can update translation resource 56 to incorporate the feedback. To this extent, it should be understood that the updating of translation resource(s) need not be automatic. Rather, it could be made subject to the approval of an administrator 58 or the like. As such, resource update system 40 need not be part of translation engine 30. In contrast, it could be maintained as a separate system. In any event, updating translation resource 56 could involve adding a new meaning for the term “pin.” Moreover, the updating could involve modifying the translation resource 56 to incorporate the different contexts in which the term could be used. As such, the entire sentence PLEASE ENTER YOUR PIN NUMBER could be assigned a certain translation.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

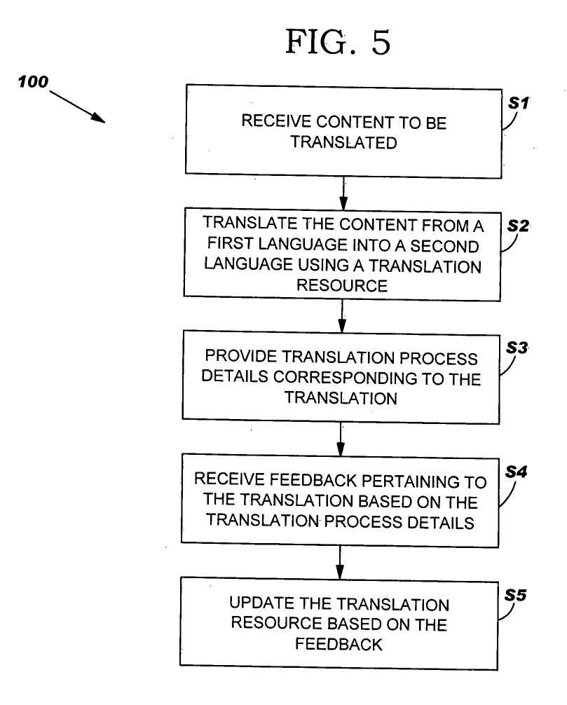

Referring now to FIG. 5, a method flow diagram 100 according to the present invention is shown. As depicted, first step S1 is to receive content to be translated from a first language into a second language. Second step S2 is to translate the content from the first language to the second language using a translation resource. Third step S3 is to provide translation process details corresponding to the translation. Fourth step S4 is to receive feedback pertaining to the translation based on the translation process details. Fifth step S5 is to update the translation resource based on the feedback.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the illustrative representation of translation engine 30 shown in FIG. 1 is not intended to be limiting. That is, the functions of the present invention described herein could be represented by a different configuration of systems.

1. An autonomic translation method, comprising:
receiving content to be translated;
translating the content from a first language to a second language using a translation resource;
providing translation process details corresponding to the translation; and
receiving feedback pertaining to the translation based on the translation process details.

2. The method of claim 1, further comprising updating the translation resource based on the feedback.

3. The method of claim 1, wherein the translation process details specify a context in which the content was translated from the first language to the second language.

4. The method of claim 1, wherein the method is computer-implemented.

5. The method of claim 4, wherein the content is received on a server over the network from a user operating a client.

6. The method of claim 1, wherein the feedback is received from a user requesting the translation.

7. The method of claim 1, wherein the providing step comprises displaying the content in the first language and in the second language in an interface page.

8. A computer-implemented business method for autonomic content translation, comprising:
receiving content to be translated from a user;
translating the content from a first language into a second language using a translation resource;
providing translation process details specifying a context of the translation to the user;
receiving feedback from the user pertaining to a quality the translation based on the translation process details; and
updating the translation resource based on the feedback.

9. The business method of claim 8, wherein the step of providing comprises providing an interface page to the user, wherein the context of the translation is displayed in the interface page, and wherein the interface page includes a mechanism for the user to provide the feedback.

10. The business method of claim 8, wherein the translation resource comprises a field dictionary.

11. The business method of claim 8, wherein the method is implemented over a network.

12. The business method of claim 8, wherein the user operates a client and communicates the content to a server in the first language for translation into the second language.

13. The business method of claim 8, wherein the translating is performed on a subscription basis.

14. An autonomic translation system, comprising:
a content reception system for receiving content to be translated from a user;
a translation system for translating the content from a first language into a second language using a translation resource;
a translation context system for providing translation process details specifying a context of the translation to the user; and
a feedback reception system for receiving feedback from the user pertaining to a quality the translation based on the translation process details.

15. The system of claim 14, further comprising a resource update system for updating the translation resource based on the feedback.

16. The system of claim 14, wherein the translation context system provides an interface page to the user, wherein the context of the translation is displayed in the interface page, and wherein the interface page includes a mechanism for the user to provide the feedback.

17. The system of claim 14, wherein the translation resource comprises a field dictionary.

19. The system of claim 14, wherein the user operates a client and communicates the content to a server in the first language for translation into the second language.

20. The system of claim 19, wherein the client and the server are connected over a network.

21. A program product stored on a recordable medium for translating content, which when executed, comprises:
program code for receiving content to be translated from a user;
program code for translating the content from a first language into a second language using a translation resource;
program code for providing translation process details specifying a context of the translation to the user; and
program code for receiving feedback from the user pertaining to a quality the translation based on the translation process details.

22. The program product of claim 21, further comprising program code for updating the translation resource based on the feedback.

23. The program product of claim 21, wherein the program code for providing provides an interface page to the user, wherein the context of the translation is displayed in the interface page, and wherein the interface page includes a mechanism for the user to provide the feedback.

24. The program product of claim 21, wherein the translation resource comprises a field dictionary.

25. The program product of claim 21, wherein the user operates a client and communicates the content to a server on which the program product is loaded.

26. The program product of claim 25, wherein the client and the server are connected over a network.
